(19) United States
(12) Patent Application Publication
(10) Pub. No.: US 2006/0078399 A1
(43) Pub. Date: Apr. 13, 2006

(54) Blindly installed, reinforceable nuts for joining structural members

(75) Inventors: David J. Coddington, (US); Jude H. Restis, (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Fatigue Technology, Inc., Seattle, WA (US)

(21) Appl. No.: 10/965,233

(22) Filed: Oct. 13, 2004

(51) Int. Cl. F16B 37/04

(52) U.S. Cl. 411/38

(57) ABSTRACT

A blind nut installed in a structural joint provides an interference fit and a fatigue enhancing benefit to the structural joint. A bolt can be inserted into the nut for additional shear strength and shear continuity. During installation in the structural joint, a first flange of the nut is seated against a first structural member, an installation tool is inserted into a passage in the nut, and the tool is operated to buckle a collapsible portion of the nut to form a second flange on a second structural member. Contemporaneously, an expandable portion of the nut is radially expanded into the structural joint. The installation process induces a high interference fit and may also induce a residual compressive stress in the structural joint.

### BACKGROUND OF THE INVENTION

1. Field of the Invention

This disclosure relates to a blindly installed nut that joins at least two structural members and can be reinforced with a bolt.

2. Description of the Related Art

High strength, permanently installed shear-rated fasteners are used extensively throughout an aerospace vehicle, such as an airplane. The purpose of such fasteners is to provide a shear transfer load path between structural members, for example panels, webs, flanges, etc. For instance, one structural member can be the wing skin while the other structural member can be a rib in the internal wing. As aerodynamic loads are applied to the wings, the wings bend and twist, thus causing the wing skin to experience tension, compression, and torsional loads. The shear-rated fasteners connecting the wing skin to the wing ribs permit the aerodynamic loads to be transferred from the wing skin into the wing box. The size, configuration, and strength of the shear-rated fasteners are dependent on the loading criteria that the airplane is expected to encounter in service.

One type of shear-rated fastener in use in the aerospace industry for transferring shear loads is the HI-LOK® fastener. The HI-LOK® fastener is comprised of a bolt portion and a collar. In a typical application, the HI-LOK® fastener is inserted in the openings of two adjacent structural members. A shank of the bolt portion is sized to at least tightly fit into the openings of the structural members. External threads of the HI-LOK® fastener are received by a expandable portion of the collar. A hex-shaped portion of the collar is attached to the expandable portion and configured to accept a socket wrench. The hex-shaped portion is configured to shear off at a predetermined torque level, thus preventing the HI-LOK® fastener from being over-torqued.

Another type of fastener that is commonly used for transferring shear loads between panels is a standard rivet. Rivets can be installed quickly by experienced aerospace assembly workers and are generally lighter than other fasteners, such as the HI-LOK® fastener. Rivets are typically made from a malleable material such as Aluminum. During installation, a shank of the rivet is placed into the opening of the structural joint. A head of the rivet is placed against one side of the structural joint. The opposing end of the rivet, which protrudes from an opposite of the structural joint, is bucked to form an opposing head. The bucking of the rivet causes some radial expansion of the rivet, forcing the rivet to fill the opening. Filling the opening with the rivet material provides shear continuity in the joint by establishing a tight fit between the rivet and the members of the structural joint. The amount of hole filling achieved by a given rivet installation, however, is dependent on the skill of the installer and other subjective factors.

The installation of both HI-LOK® fasteners and rivets typically requires that an installer have access to both sides of the structural joint. Unlike the HI-LOK fasteners and standard rivets, blind fasteners are installed from only one side of a structural joint. FIG. 1 illustrates one example of a blind fastener 1 that is used in at least two structural members 2a, 2b. The illustrated fastener 1 is called a BLINDNUT® fastener and is manufactured by Hi-Shear Corporation. The BLINDNUT® fastener 1 is comprised of a sleeve 3 and an expander 4. The sleeve 3 includes a head 5 and a shank 6. The shank 6 extends through the openings 7a, 7b of the structural members 2a, 2b, respectively. The head 5 is seated against the structural member 2a while an extended portion 8 of the shank 6 extends beyond the external side of the structural member 2b. The expander 4 is press fit into the extended portion 8 of the shank 6. The expander 4 causes the extended portion 8 of the shank 6 to radially expand or bulge out. The bulged, extended portion 8, in conjunction with the head 5, provides axial retention of the sleeve 3 in the structural members 2a, 2b.

There is a need for a fastening apparatus that can be installed blindly into more than a single structural member, that can provide an enhanced fatigue benefit to the structural members, and that can be utilized in a variety of load transfer situations.

### SUMMARY OF THE INVENTION

In one aspect, a fastener connects at least two structural members having respective holes extending through a width of the respective structural members where the holes may be aligned to receive at least a portion of the fastener therethrough. The fastener includes a nut having a first end and a second end opposed to the first end, the nut having a pre-formed flange formed proximate the first end of the nut, the nut having a shaft extending from the pre-formed flange toward the second end of the nut, the shaft of the nut forming an engagement structure located towards the second end of the nut, and the shaft having a collapsible wall portion between the first and the second ends of the nut, the collapsible portion spaced from the pre-formed flange such that a second flange formed by the collapsing of the collapsible wall portion is located from the pre-formed flange by a distance that is approximately equal to the combined thickness of the two structural members, and where at least a radially expandable portion of the shaft extending between the pre-formed flange and the collapsible portion has a perimeter sized to be closely received through the openings of the at least two structural members and the radially expandable portion is sufficiently malleable to form an interference fit with the structural members in response to a radial expansion of the radially expandable portion.

In another aspect, a method installs a blind, collapsible fastener into a structural joint, the structural joint comprises a plurality of structural members with aligned respective openings therethrough and the fastener includes a nut member and a bolt member. The method includes inserting the nut member into the structural joint, the nut member comprising a first flange, an expandable portion, a collapsible portion, and a second portion, the expandable portion sized to extend substantially through the openings in the structural joint, the expandable portion having a first flange for seating against a surface of the structural joint, the expandable portion having an outer perimeter sized to form a close fit in the openings in the structural joint, the second portion having an inner perimeter and an outer perimeter, at least a region of the inner perimeter forming a first engagement structure; seating the first flange of the nut member against a first surface of a first structural member of the structural joint; forming the second flange proximate to a second surface of a second structural member of the structural joint; radially expanding the expandable portion of the nut member into the openings of the structural joint to provide a tight interference fit between the nut member and the structural joint; and engaging a bolt with the nut member, the bolt sized to closely fit within the radially expanded nut member to provide additional shear strength and continuity within the structural joint, the bolt having a complementary second engagement structure for engaging the first engagement structure of the nut member.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a cross sectional view of a blind fastener assembly according to the prior art.

FIG. 2 is a front, left, isometric view of a separated nut assembly having a nut member and a cap according to one illustrated embodiment.

FIG. 3 is a front, left, isometric view of an assembled version of the nut assembly of FIG. 2.

FIG. 4 is a cross sectional view of the nut assembly of FIG. 3 with a reduced wall section defining a collapsible portion of the assembly according to one illustrated embodiment.

FIG. 5 is a cross sectional view of the nut assembly of FIG. 3 with a modified, but same thickness section defining a collapsible portion of the assembly according to one illustrated embodiment.

FIG. 6 is a cross sectional view of the nut assembly of FIGS. 2 and 3 having a formed second flange and fixed in a structural joint according to one illustrated embodiment.

FIG. 7 is a cross sectional view of the nut assembly of FIGS. 2 and 3 used to attach a repair patch to a structural joint according to one illustrated embodiment.

FIG. 8A is a partial isometric, partial cross-sectional view of a finite element mesh representative of a structural joint with applied loads from the nut assembly of FIGS. 2 and 3.

FIG. 8B is a cross-sectional view of the finite element mesh of FIG. 8A taken along line A-A.

FIG. 9 is a bar chart illustrating the enhanced fatigue benefit achieved in a structural joint having the installed nut assembly of FIGS. 2 and 3.

FIG. 10 is a line chart illustrating the enhanced fatigue benefit achieved in a structural joint having the installed nut assembly of FIGS. 2 and 3.

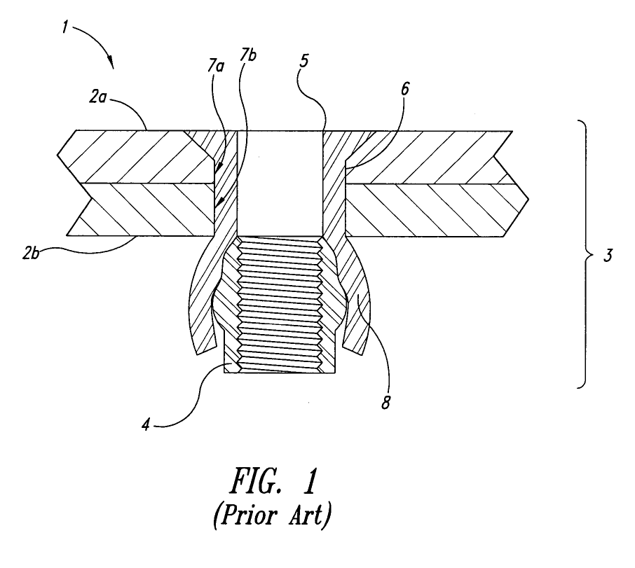

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fastening systems, installation aspects of blind, partially collapsible fastener assemblies, and various types of tooling used to install the blind, partially collapsible fastener assemblies have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

The use of the terms “nut” or “nuts” herein refers to a fastening element having a passageway where the passageway is configured with an engagement portion. The passageway may be a through-passage or may only extend partially through the nut. Typically, the engagement portion is a plurality of internal threads configured to receive a bolt or screw, but the engagement portion can be another mechanical engagement that performs a similar function.

The headings provided herein are for convenience only and do not interpret the scope or meaning of the claimed invention.

The following description relates to a type of nut that can be blindly installed with a cold expansion process and a contemporaneous collapsing process of a portion of the nut to form a second flange. A special tool is used to radially expand the nut into the opening in the structural joint. The radial expansion creates an interference fit that is resistant to torque and pushout. The expansion process locks the nut into the structural joint and then a common aerospace screw or bolt may be used to reinforce the nut within the structural joint. The blindly installed nut disclosed herein may be used under a number of different loading conditions, for example shear, tension, or compression.

At least one embodiment of the present invention can be used to attach accessory components to the structural joint or structural member, for example attaching a fuel pump to a web (e.g., the structural member) of the wing box. The installation of the nut according to any of the disclosed embodiments provides fatigue life enhancing benefits that may substantially extend the fatigue life of the structural joint. The fatigue life enhancing benefits are derived through the cold expansion process, the resultant interference fit, and the buckling process used to form the second flange. These contemporaneously performed processes may introduce residual compressive stresses in the structural joint. The residual compressive stresses provide the structural joint with an improved resistance to fatigue cracking and may even provide some measure of crack retardation (i.e., slowed crack growth). The nuts can be manufactured in a non-sealed version or a sealed version, the latter version being used for joining structural members in a fuel tank environment, for example.

The mechanical, radial expansion of the nut also provides a degree of mechanical sealing, which may be further enhanced by the application of a sealant. A sealable, blindly installed nut that is radially expanded into a single structural member is disclosed in detail in U.S. patent application Ser. No. 10/928,641, filed on Aug. 24, 2004, and entitled “SEALED, BLIND FASTENER ASSEMBLY.” That application teaches to use the nut as a bushing in a single structural member or as an installation nut in a single structural member to attach an accessory component.

Sealed, Blindly Installed Nuts with Cap Included

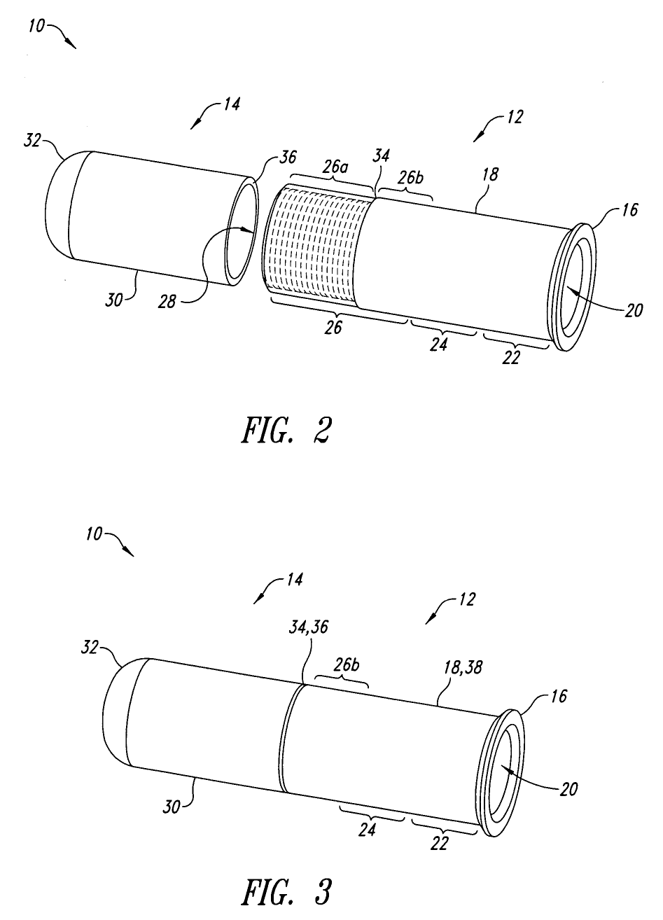

FIGS. 2 and 3 show a nut 10 according to one illustrated embodiment of the present invention. The nut 10 is comprised of a nut member 12 and a cap 14.

The nut member 12 includes a first flange 16 and a body 18 having a passageway 20 therethrough. The body 18 includes an expandable section 22, a collapsible portion 24, and may include cap-receiving section 26. One skilled in the art will appreciate and understand that the nut 10 may be installed and/or used without a cap 14. In one embodiment, the cap 14 includes an inner surface 28, an outer surface 30, and a sealed end segment 32. The cap 14, as illustrated, is further configured with a thin-walled body. One skilled in the art will appreciate and understand that one parameter for determining the thickness of the thin-walled body of the cap 14 is the pressure that the cap 14 will be subjected to during operation.

The inner surface 28 of the cap is sized to closely fit onto a portion of the cap-receiving surface 26 of the nut member 12. The cap 14 can be press fit onto a expandable portion 26a of the cap-receiving surface 26, bonded onto the expandable portion 26a, threaded onto the expandable portion 26a, and/or attached to the expandable portion 26a in an equivalent manner. For example, the cap 14 can be press fit and bonded onto the expandable portion 26a. In addition, a sealant (not shown) can be applied at a shoulder 34, which is defined as a step between the expandable portion 26a and a second portion 26b of the cap-receiving portion 26. The sealant is used to seal the interface between the cap 14 and the nut member 12. One type of sealant that can be used to seal the interface is an adhesive-type sealer under the LOCKTITE® brand and supplied by the 3M Corporation. The sealant protects against fluid leakage into the nut 10. In one embodiment, the nut 10 is installed in a fuel tank with the cap 14 being wetted by the fuel. A tight fit between the cap 14 and the cap-receiving surface 26 of the nut member 12 in combination with the sealant can decrease the likelihood that fuel will seep through the interface region located between the nut member 12 and the cap 14.

The shoulder 34 may provide a stop for the cap end 36. In one embodiment, the shoulder 34 is utilized to allow mass produced caps 14 to be repeatedly placed onto the cap-receiving surface 26 to a standard depth. The cap end 36, however, is typically configured to be located within a distance of approximately 0.020 inches or less from the shoulder 34 and it is not required that the cap end 36 be placed into contact with the shoulder 34.

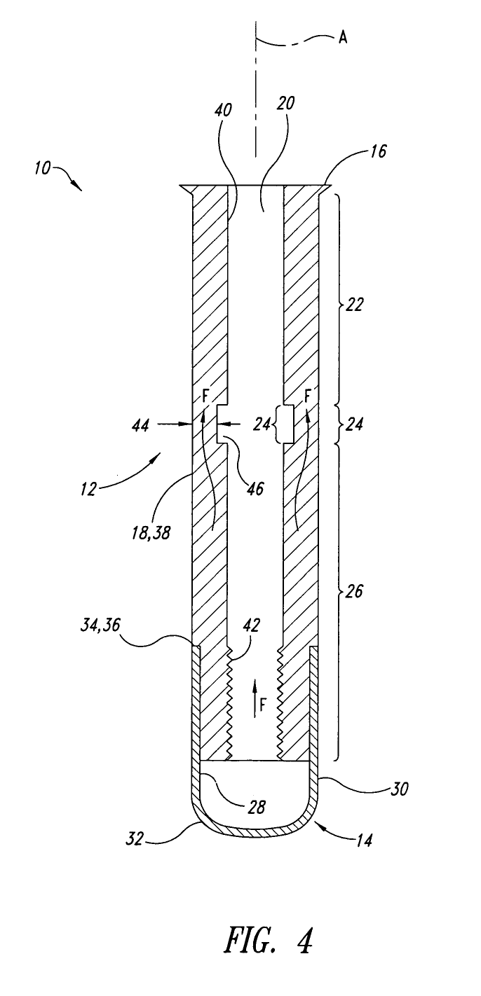

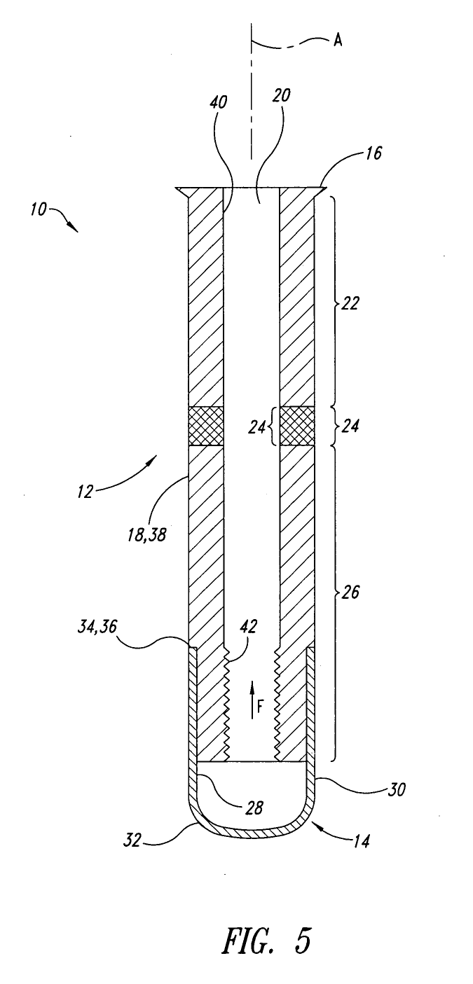

FIG. 4 illustrates a cross-section of the nut 10 according to one illustrated embodiment. In reference to the connection between the cap 14 and the nut member 12, FIG. 4 shows that the outer surface 30 of the cap 14 is sized to be approximately equal to and relatively flush with the outer surface 38 of the body 18 of the nut member 12. The outer surface 30 of the cap 14, however, can be slightly larger, equal to, or even smaller than the outer surface 38 of the body 18 of the nut member 12. But, the outer surface 30 of the cap 14 is restricted from being substantially larger than the outer surface 38 of the nut member 12, otherwise the cap 14 would not adequately fit through an opening in a structural joint (FIG. 6). One skilled in the art will appreciate and understand that both the cap 14 and the opening in the structural joint are subject to tolerance variations.

In the illustrated embodiment, the passage 20 of the nut member 12 extends through the nut member 12. The collapsible portion 24 and one embodiment of an engagement section 42 are formed on an inner surface 40 surrounding the passage 20 of the nut member 12. The passage 20 permits the nut 10 to receive an installation tool (not shown) or a bolt, both of which are discussed below in further detail. A rod of the installation tool is configured to couple with the engagement portion 42 during the installation of the hut 10 into a structural joint.

In the embodiment illustrated in FIG. 4, the collapsible portion 24 is comprised of a reduced thickness wall portion 44. The reduced thickness wall portion 44 is designed to buckle or collapse when the nut 10 is subjected to an amount of force “F” applied by the rod of the tool in a substantial axial direction “A” and along the force vector “F.” The reduced thickness wall portion 44 establishes an eccentric load path through the nut member 12 in which the force “F” must be directed around the cutout segment 46 of the collapsible portion 24, thus increasing the applied stress in this localized region of the nut 10. One skilled in the art will appreciate and understand that the nut member 12 during installation is a structural column under compression and is subject to local buckling in which the manner and location of buckling is dependent on the applied stress in the column, which in turn, happens to be magnified due to the formed eccentricity 46.

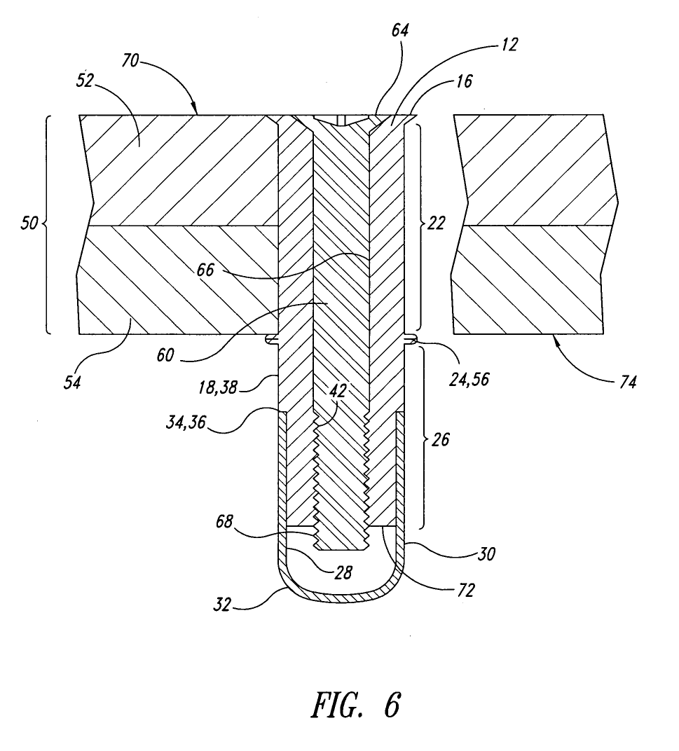

In another embodiment illustrated in FIG. 5, the collapsible portion 24 is crosshatched to represent that the collapsible portion 24 has different physical properties than the physical properties of the remainder of the nut member 12. In one embodiment, the physical properties of the collapsible portion 24 are altered through an annealing process that locally reduces the strength or critical buckling capability of the collapsible portion 24 with respect to the remaining portion. One process that can be used to weaken the collapsible portion 24 is a process known as induction coil annealing, also referred to as band annealing, although other equivalent processes may also be used. The annealed or weakened collapsible portion 24 is configured to structurally fail, whether due to buckling, compression, or some other failure mode or combination thereof, when subjected to an amount of force “F.”

FIG. 6 shows the nut 10 installed into a structural joint 50. The structural joint 50 includes at least a first structural member 52 and a second structural member 54. The structural members 52,54 can be a wing skin and a chord or attachment flange of a wing rib, respectively. One skilled in the art will understand and appreciate that the structural joint 50 may be comprised of more than two structural members, however the discussion herein shall make reference to only two structural members making up the structural joint for clarity.

The expandable portion 22 is sized to be closely received by the opening in the structural joint 50 and further sized to extend between the first flange 16 and the collapsible portion 24 to accommodate the thickness of the structural members 52,54 of the structural joint 50. The expandable portion 22 is sufficiently malleable to form an interference fit with the structural members 52, 54 as the expandable portion 22 is radially expanded, as explained in more detail below.

The collapsible portion 24 is shown in a post-buckled or collapsed state. In the collapsed state, the collapsible portion 24 forms a second flange 56 that may be in tight contact with the surface of the second member 54. One skilled in the art will understand and appreciate that the second flange 56 can be in tight contact with, have no direct contact with, or be separated by another structural member, such as a washer, from the second member 54. The first flange 16 and the second flange 56 work in combination to apply compression to and restrain the structural members 52,54 of the structural joint 50.

In the illustrated embodiment, the engagement section 42 of the nut member 12 can be a plurality of internally machined threads, which can be formed as either rolled or cut threads. The engagement section 42 serves a number of functions. One function of the engagement section 42 is to allow the nut member 12 to be selectively and detachably coupled with the threaded rod of the installation tool. During installation, the threaded rod of the installation tool is moved into the passageway 20 and threaded into the engagement section 42 of the nut member 12. Once the rod is sufficiently engaged with the engagement section 42, the installation tool retracts the rod by leveraging against the surface of the first structural member 52, which may also include leveraging against the first flange 16 recessed therein. In one embodiment, the installation tool generates the predetermined force “F” required to buckle or collapse the collapsible portion 24 through the cooperation of hydraulic chambers and pistons within the installation tool.

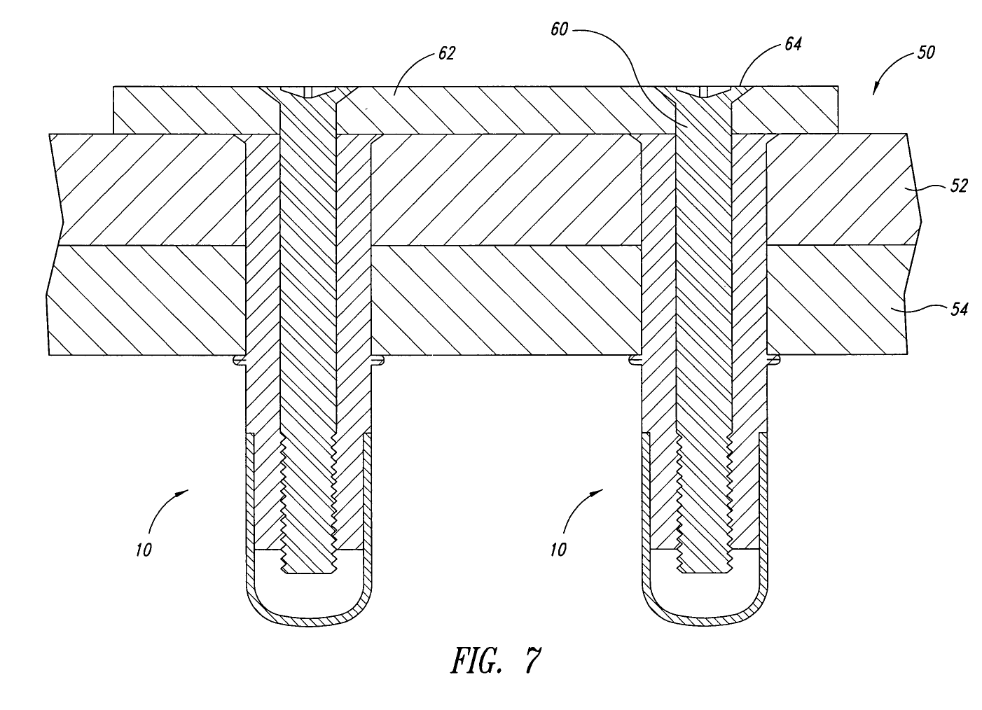

Another function of the engagement section 42 is to allow a bolt 60 (sometimes referred to as a fastener or screw) to engage and be retained in the nut 10. The bolt 60 can provide structural reinforcement to the nut 10 by providing increased stiffness, increased strength, and better shear continuity across the hollow nut 10. Although the increased stiffness, strength, and shear continuity may not be necessary for all design purposes, the configuration of the nut 10 at least provides for the option of including a bolt 60. Additionally or alternatively and illustrated in FIG. 7, the bolt 60 can be used to attach another component 62, such as a repair strap, to the structural joint 50.

Referring back to FIG. 6, the bolt 60 includes a bolt head 64, a shank 66, and a threaded region 68. The head 64 can be complementarily formed to recess into the first flange 16. In assemblies that will be subjected to aerodynamic loads, the head 64 is often required to be substantially flush with a surface 70 of first structural member 52. The shank 66 is sized to be closely received by the post-expanded, expandable portion 22 of the nut 10. The threaded region 68 is configured to engage at least some of the internal machined threads 42 of the nut 10. The length of the bolt 60 should be restricted to extend only a few threads beyond a terminal end 72 of the nut member 12.

Installation of the Sealed, Blind Fastener Assembly into a Work Piece

The installation of nut 10 into the opening in the structural joint 50 is accomplished with an installation tool. The discussion herein regarding the installation tool and the general method of installation is stated with brevity because the specifics and details can be found in U.S. Pat. No. 6,487,767 issued to Reid et al.

The nut 10 is installed into the opening in the structural joint 50 with an installation tool comprised of a housing, a threaded engagement rod, and a mandrel. The threaded engagement rod cooperates with the mandrel to collapse or buckle the collapsible portion 24 of the nut member 12 onto the surface 74 of the second structural member 54 and to radially expand the expandable portion 22 into the structural joint 50. As the collapsing occurs, the threaded engagement rod is cooperating with the mandrel to force the mandrel into the passage 20. The mandrel is sized to be slightly larger than the inner perimeter 38 of the passage 20, thus causing the expandable portion 22 to radially expand into the members 52, 54 of the structural joint 50. The forming of the second flange 56 contemporaneously with the radial expansion of the expandable portion 22 establishes a secure, interference fit between the nut 10 and the opening in the structural joint 50. One skilled in the art will appreciate and understand that it may be necessary to perform a final reaming operation in the opening or oversize the opening in the structural joint 50 to assure that the expandable portion 22 is closely received by both structural members 52, 54 of the structural joint 50.

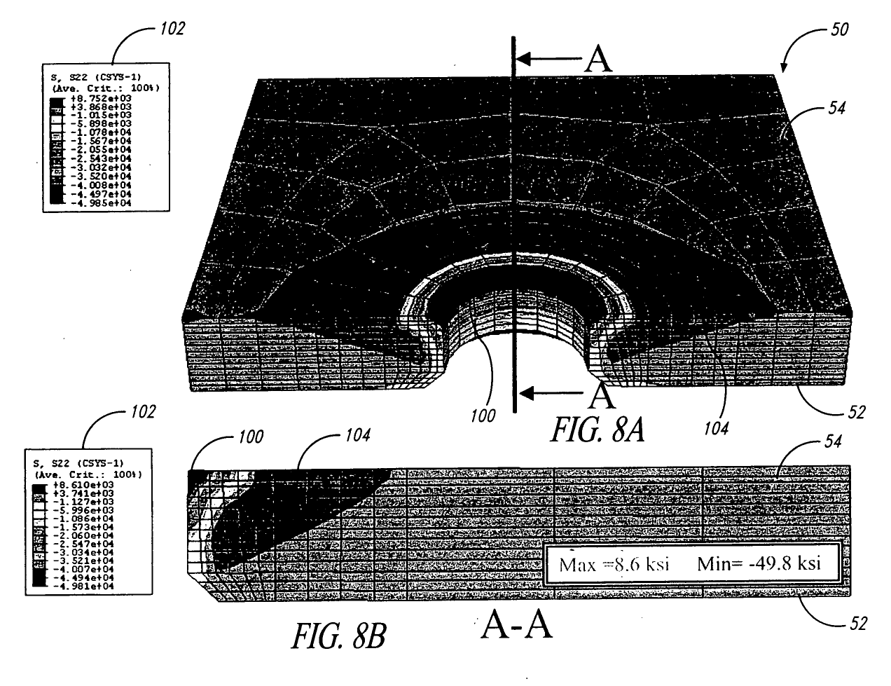

The forming of the second flange 56 in conjunction with the radial expansion of the expandable portion 22 may create a residual compressive stress in the members 52, 54 of the structural joint 50 according to one illustrated embodiment shown in FIGS. 8A and 8B. FIGS. 8A and 8B show a finite element model (FEM) of an exemplary structural joint 50 having a first structural member 52, a second structural member 54, and employing the structures and methods described herein. The residual compressive stress is largest in magnitude in a first region 100 of the structural joint 50. The first region 100 is adjacent to or proximate to the second flange 56 formed from the collapsible portion 24 (FIG. 8B). The legend 102 of the FEM indicates that a maximum residual compressive stress of approximately −49.8 ksi is achieved in the region 100 of the structural members 52, 54, in which the structural members 52, 54 happen to made from Aluminum in the illustrated embodiment. One skilled in the art will appreciate and understand that although the installation of the nut 10 also generates tension stresses in region 104, the highest operating stresses arise in proximity to the opening in the structural joint 50 due to the stress concentration effect of the opening. Thus, the interference fit and the residual compressive stresses generated adjacent to the opening provide an enhanced fatigue benefit for the structural joint 50.

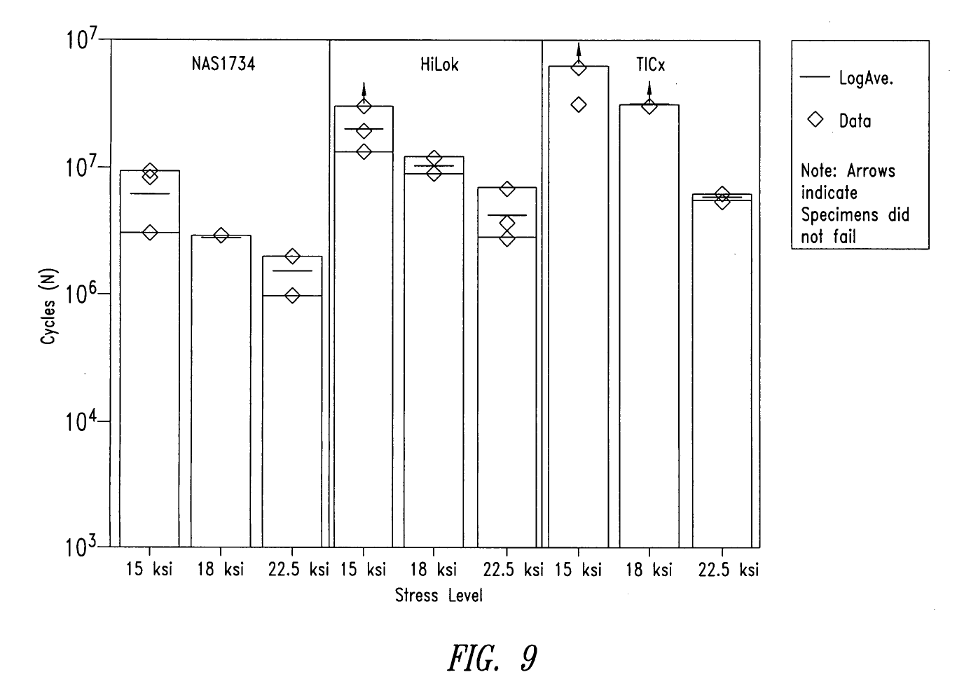

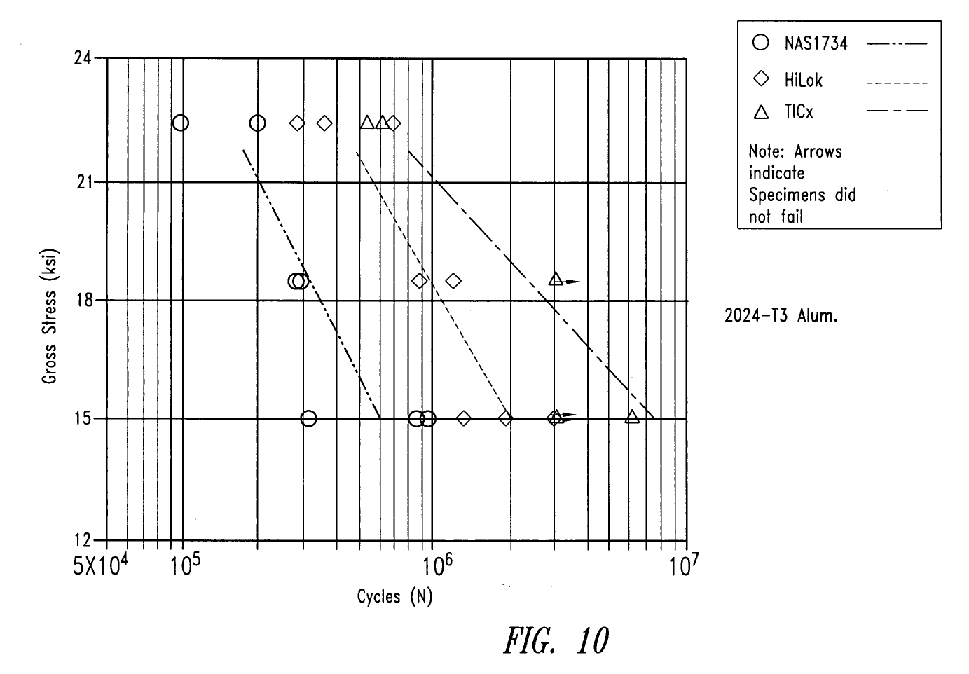

FIGS. 9 and 10 show that the induced residual compressive stresses provide an increase in the fatigue life (i.e., number of cycles) under three different applied stresses of 15.0 ksi, 18.0 ksi, and 22.5 ksi. The nut 10 (re: TlCx in FIGS. 9 and 10) was compared to a HI-LOK® fastener and a standard NAS1734 fastener with the respective fasteners being installed in an Aluminum dogbone specimen. Thus, the method of installation and the configuration of the nut 10 taught herein provide an enhanced fatigue benefit for the structural joint 50.

In addition to the above fatigue benefits, the potential residual compressive stresses around the opening of the structural joint 50 may also act to retard any crack growth. For example, if a crack were to form out of one of the fastener openings, the depth of the potential residual compressive stress into the material of the structural joint would retard or slow the growth rate of the crack, until the crack grew beyond the residual compressive region and entered the tension region 104 indicated in FIGS. 8A and 8B.

One advantage of the nut 10 is that the cap 14 can be assembled with the nut member 12 after the threads 42 have been machined. This installation sequence permits the threads 42 to be thoroughly cleaned and inspected before placing the cap 14 onto the nut member 12. The two-part nut 10 provides a low cost fastener that can be manufactured with high quality, reliable internal threads.

Another advantage of the nut 10 is that the fatigue benefit generated from the inducement of the residual compressive stress in the structural joint 50 influences both structural members 52, 54. In addition, the formation of the second flange 56 in combination with the radial expansion of the expandable portion 22 maximizes the residual compressive stress in the region 100 of the structural joint 50 that is nearest the second flange 56 (see FIGS. 8A and 8B). Because the second flange 56 is formed on the “blind side” or “difficult to inspect side” of the structural joint 50, the increased residual compressive stresses in that region may provide additional assurance against the initiation or fast growth of a fatigue crack. This is advantageous because finding a crack on the blind side of a structural joint is quite difficult, even with ever-improving non-destructive inspection (NDI) techniques.

Yet another advantage of the nut 10 is that the nut 10 can be reinforced with bolt 60 to provide additional stiffness, strength, and/or shear continuity to the structural joint 50. The configuration of the nut 10 permits the nut member 12 to receive the threaded rod of the installation tool and then, after the nut has been radially expanded, the nut member 12 can receive the bolt 60.

In yet another advantage, the interference fit of the nut 10 in the structural joint 50 can provide a means to seal an opening in the structural joint 50. The high interference fit in combination with the formed second flange 56 can substantially prevent moisture from being transferred through the opening in the structural joint 50. As discussed above, the fastener with the cap can fill the opening in the structural joint to substantially prevent fuel leakage from inside a fuel tank. The sealing capability of the fastener can be augmented with the use of a sealant.

The various embodiments described above can be combined to provide further embodiments. All of the above U.S. patents, patent applications and publications referred to in this specification as well as U.S. patent application Ser. No. 10/928,641, filed on Aug. 24, 2004, and entitled “SEALED, BLIND FASTENER ASSEMBLY” are incorporated herein by reference. Aspects of the invention can be modified, if necessary, to employ devices, features, and concepts of the various patents, applications and publications to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all blindly installed fastener assemblies that operate in accordance with the claims. Accordingly, the invention is not limited by the disclosure, but instead its scope is to be determined entirely by the following claims.

1. A fastener to connect at least two structural members having respective holes extending through a width of the respective structural members where the holes may be aligned to receive at least a portion of the fastener therethrough, the fastener comprising:
a nut having a first end and a second end opposed to the first end, the nut having a pre-formed flange formed proximate the first end of the nut, the nut having a shaft extending from the pre-formed flange toward the second end of the nut, the shaft of the nut forming an engagement structure located towards the second end of the nut, and the shaft having a collapsible wall portion between the first and the second ends of the nut, the collapsible portion spaced from the pre-formed flange such that a second flange formed by the collapsing of the collapsible wall portion is located from the pre-formed flange by a distance that is approximately equal to the combined thickness of the two structural members, and where a radially expandable portion of the shaft of the nut extends between the pre-formed flange and the collapsible portion, the radially expandable portion includes a perimeter sized to be closely received by the openings of the at least two structural members, the radially expandable portion is radially expandable to rotationally fix the nut to at least one of the structural members.

2. The fastener of claim 1 wherein the nut has a passage extending from the first end toward the second end.

3. The fastener of claim 1 wherein the passage extends through the pre-formed flange, through the shaft, and through the second end of the nut.

4. The fastener of claim 2, further comprising:
a bolt having an outer perimeter sized to be received in the passage after radial expansion of the nut.

5. The fastener of claim 4 wherein the engagement structure comprises at least one thread formed in the passage proximate the second end of the nut.

6. The fastener of claim 5, further comprising:
a bolt having an outer perimeter sized to be received in the passage, the bolt having at least one thread formed to complementarily engage the at least one thread formed in the passage of the nut.

7. The fastener of claim 1, further comprising:
a sealing cap received over the second end of the nut.

8. The fastener of claim 1 wherein the engagement structure comprises at least one bearing surface extending approximately perpendicularly with respect to a longitudinal axis of the shaft.

9. The fastener of claim 1 wherein the collapsible wall portion comprises a reduced wall thickness section of the shaft.

10. The fastener of claim 1 wherein the collapsible wall portion comprises a reduced wall strength section of the shaft.

11. The fastener of claim 1 wherein the second flange is seated against the one of the structural members after the collapsing of the collapsible wall portion.

12. A method for installing a blind, collapsible fastener into a structural joint, the structural joint comprising a plurality of structural members with aligned respective openings therethrough, the fastener comprising a nut member and a bolt member, the method comprising:
inserting the nut member into the structural joint, the nut member comprising a first flange, an expandable portion, a collapsible portion, and a second portion, the expandable portion sized to extend substantially through the openings in the structural joint, the expandable portion having a first flange for seating against a surface of the structural joint, the expandable portion having an outer perimeter sized to form a close fit in the openings in the structural joint, the second portion having an inner perimeter and an outer perimeter, at least a region of the inner perimeter forming a first engagement structure;
seating the first flange of the nut member against a first surface of a first structural member of the structural joint;
forming the second flange proximate to a second surface of a second structural member of the structural joint;
radially expanding the expandable portion of the nut member into the openings of the structural joint to provide a tight interference fit between the nut member and the structural joint; and
engaging a bolt with the nut member, the bolt sized to closely fit within the radially expanded nut member to provide additional shear strength and continuity within the structural joint, the bolt having a complementary second engagement structure for engaging the first engagement structure of the nut member.

13. The method of claim 12 wherein forming the second flange includes collapsing the collapsible portion.

14. The method of claim 13 wherein collapsing the collapsible portion includes applying a predetermined amount of force to the nut member.

15. The method of claim 12 wherein radially expanding the expandable portion of the nut member into the openings of the structural joint includes inducing a residual compressive stress into the structural joint in proximity to the openings.

16. The method of claim 12 wherein seating the first flange of the nut member against the first surface of the structural joint includes applying pressure on the first flange with an installation tool to maintain the first flange against the first surface.
